(19) United States
(12) Patent Application Publication
(10) Pub. No.: US 2020/0113271 A1
(43) Pub. Date: Apr. 16, 2020

(54) FEEDBACK-GENERATING FOOTWEAR HAVING FEEDBACK-PRODUCING ZONES

(71) Applicant: Eitan Kramer, Los Angeles, CA (US)

(72) Inventor: Eitan Kramer, Los Angeles, CA (US)

(21) Appl. No.: 16/653,929

(22) Filed: Oct. 15, 2019

Related U.S. Application Data
(60) Provisional application No. 62/745,193, filed on Oct. 12, 2018.

(51) Int. Cl. A43B 3/00; G06F 3/16; H04R 1/02; G08B 7/06; H04B 1/3827; H04W 4/38

(52) U.S. Cl. CPC A43B 3/0005; G06F 3/165; H04W 4/38; G08B 7/06; H04B 1/385; H04R 1/028

(57) ABSTRACT

Footwear having one or more sensors, where each of the one or more sensors is positioned at a corresponding region of an inner and/or outer region of the footwear. Each of the one or more sensors has an assigned feedback that is dynamically assigned by or via a remote computing device, the assigned feedback being generated upon activation of each of one of the one or more sensors to generate the assigned feedback. The footwear further includes a processor coupled with the one or more sensors to process the assigned feedback generated by each of the one or more sensors to produce an electrical signal representing the assigned feedback generated by each of the one or more sensors. The footwear can further include an output coupled with the processor to generate an audio or visual output signal of the electrical signal representing the assigned feedback.

### CROSS-REFERENCE TO RELATED APPLICATION

The present application claims the benefit of U.S. Provisional Application No. 62/745,193, filed Oct. 12, 2018 entitled “Sound-Playing Footwear Having Sound-Producing Zones,” the disclosure of which is incorporated herein by reference in its entirety.

### BACKGROUND

All footwear is tailored for at least some activity, ranging from protecting one's feet while walking over a surface, to improving one's performance in a challenging sport, to facilitating recovery from a foot injury or medical procedure. Some footwear, such as running sneakers or shoes, can track certain foot-related metrics via sensors, such as cadence, distance, foot pressure on a surface, or alignment, etc.

All footwear shares some common features and components. For example, all footwear has a footbed, on which a wearer's foot rests, and which may or may not extend completely along the wearer's foot. The footbed can include or be defined by an insole. In some footwear, such as running shoes or other athletic shoes, the insole may include multiple layers, such as an inner sole and a midsole. All footwear further has a sole, also called an outsole in some footwear, which defines an outer surface or layer under the wearer's foot, and which contacts a surface when the wearer is running, walking, standing or even sitting. The sole can further include a toe, which supports the toes of the foot of the wearer, and a heel, which supports the heel of the foot of the wearer.

However, there is a need for footwear that not only includes sensors, but which can provide an instantaneous, intentional and distinct, dynamically-assignable feedback, which feedback can be electronically generated and output to an output device as a sound, a graphic, control, feedback, data collection, or the like.

### SUMMARY

This document describes footwear having sensors that, when the footwear is worn by a wearer and utilized and/or operated in specific, predetermined ways, can provide an instantaneous, intentional and distinct, dynamically-assignable feedback. The feedback can be electronically generated and received and processed by a processor, which preferably makes up part of the footwear, and output to an output device as a sound, a graphic, control, feedback, data collection, or the like. The footwear can be a shoe, a component of a shoe such as an insole, a midsole, an outsole, or the like, or even an attachment to a wearer's foot. Further, the footwear can be a sock or hose, a sandal or flip-flop (sometimes called a “thong”), or the like.

In some implementations, a shoe, or a component of a shoe, is described herein, where the shoe can generate a sound, such as plays a musical note, beat, or other sound, from built-in speakers when a wearer applies pressure to one of at least two sensors in distinct locations (i.e. “sound zones”) incorporated into the shoe. The shoe can include a power source, such as a rechargeable battery, which can be recharged by an external charge port such as a Universal Serial Bus (USB) port. In other implementations, the power source can be recharged by pressure activity of the shoe by the wearer.

In some aspects, this disclosure describes footwear that includes a footbed having a number of inner surface regions of the footwear, and a sole having a number of outer surface regions of the footwear. The footwear further includes one or more sensors. Each of the one or more sensors can be positioned at a corresponding region of the plurality of inner and/or outer regions of the footwear. Each of the one or more sensors has an assigned feedback that is dynamically assigned by a remote computing device to each of the one or more sensors, the assigned feedback being generated upon activation of each of one of the one or more sensors to generate the assigned feedback. The footwear further includes a processor coupled with the one or more sensors to process the assigned feedback generated by each of the one or more sensors to produce an electrical signal representing the assigned feedback generated by each of the one or more sensors. The footwear further includes an output coupled with the processor to generate an audio or visual output signal of the electrical signal representing the assigned feedback, for an output device.

In some aspects, footwear in accordance with implementations described herein includes a footbed having or providing a number of inner surface regions of the footwear, a sole having or providing a number of outer surface regions of the footwear, and one or more sensors. Each of the one or more sensors is positioned at a corresponding region of the plurality of inner and/or outer regions of the footwear. Each of the one or more sensors has an assigned feedback that is dynamically assigned by a remote computing device to each of the one or more sensors, the assigned feedback being generated upon activation of each of one of the one or more sensors to generate the assigned feedback. The footwear further includes a processor coupled with the one or more sensors to process the assigned feedback generated by each of the one or more sensors to produce an electrical signal representing the assigned feedback generated by each of the one or more sensors. The footwear can further include an output coupled with the processor to generate an audio or visual output signal of the electrical signal representing the assigned feedback.

In other aspects, a system in accordance with implementations described herein includes a computing device to execute an application that generates a display of a plurality of feedback selectable for assignment by a user, and footwear in communication with the computing device, where the footwear is substantially as described above, i.e. having one or more sensors and at least one processor. The system further includes an output device coupled with the processor to generate an audio or visual output of the electrical signal representing the assigned feedback.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a bottom perspective view of footwear in the form of a shoe, illustrating a number of sound zones that include one or more sensors on a bottom of the shoe;

FIG. 2 is a back-perspective view of the shoe, illustrating a built-in or attachable speaker and sound zones, in accordance with implementations consistent with the subject matter described herein;

FIG. 3 illustrates a connector such as a latch can be used when a shoe is worn by a user and to establish an electrical circuit for conducting electrical signals by which a speaker can be powered;

FIG. 4 shows a cross-section of feedback generating footwear in accordance with implementations described herein;

FIG. 5 illustrates a system that includes a computing device to execute one or more applications; and

FIG. 6 illustrates a top and bottom of an insole, in accordance with implementations of the subject matter described herein.

Like reference symbols in the various drawings indicate like elements.

### DETAILED DESCRIPTION

This document describes footwear having one or more sensors to provide and generate one or more types of electronically-driven feedback. The feedback is communicated from the footwear to one or more electronic devices, such as a speaker or a computing device. The footwear can be provided as a pair of socks, a pair of shoes, a pair of sandals or flip-flops, or a pair of booties, a component thereof, such as an insole or insert, or the like.

Consistent with implementations described herein, all footwear shares some common features and components. For example, all footwear has a footbed, on which a wearer's foot rests, and which may or may not extend completely along the wearer's foot. The footbed can include or be defined by an insole. In some footwear, such as running shoes or other athletic shoes, the insole may include multiple layers, such as an inner sole and a midsole. All footwear further has a sole, also called an outsole in some footwear, which defines an outer surface or layer under the wearer's foot. The sole can further include a toe, which supports the toes of the foot of the wearer, and a heel, which supports the heel of the foot of the wearer.

The feedback generated by the footwear described herein can be haptic or encoded in digital signals that are communicated electronically from the sensors to the electronic devices. The communication can include one or more of a wired and a wireless medium. For example, the communication can use WiFi, Bluetooth, Web Bluetooth, cellular, or other wireless communication technology. The one or more electronic devices can include a processor that executes an application (“app,” which as used herein is distinct from an “application” as the action of putting something into a specific operation). The processor can be hardwired, such as a Field Programmable Gate Array (FPGA) or an Application Specific Integrated Circuit (ASIC), or can be configurable or programmable. The app can be a native app, a distributed app, a web-based or cloud-based app (known generally as a “web app”), or the like.

In some implementations, the footwear includes one or two shoes, or one or more components thereof, where each shoe includes one or more pressure sensors, and the shoe is configured to play sounds, i.e. through a speaker attached to the shoe, based on where and/or how much pressure a wearer applies to an area of the shoe. The sounds can also be generated by way of a microprocessor that includes a transceiver or other electronic communication channel, and which transmits the sounds to an external sound producing device such as an external speaker, headphones, earbuds, or the like. The external speaker can be part of a computing device. The sounds can be formatted in one or more sound formats, such as MP3, WAV, or the like.

In some implementations, a shoe includes a sole having sensors embedded or provided in one or more so-called “sound zones.” The sensors are preferably pressure sensors, but can also be accelerometers, voltage sensors, velocity sensors, or any other sensor that can sense, at a particular sound zone, an action by a wearer of the shoe, such as touching or moving the shoe toward a surface, for instance.

Pressure that is exerted against each sound zone, such as by the wearer contacting a primary sound zone to a surface, can cause a musical note, beat, or other sound, to be played from a built-in or detachable speaker that is attached to the shoe. In some implementations, the speaker is attached proximate to a heel of the shoe. In other implementations, the speaker can be attached to a top of the shoe, or may even be formed as a lace or other connecting mechanism that connects two parts of the shoe together to maintain its fit on a wearer's foot.

Each sound zone can define a distinct location on the shoe: one or more sound zones on the bottom of the sole, for example, and/or one or more sound zones along the sides, front, back or top of the shoe. The shoe can include a power source, such as a rechargeable battery, which can be recharged by an external charge port such as a USB port. In other implementations, the power source can be recharged by pressure activity of the shoe by the wearer. In yet other implementations, an external power source, such as a battery pack attached to a wearer's ankle, leg, or clothing, can be connected with the shoe to power the sensors and the sound producing component such as a speaker.

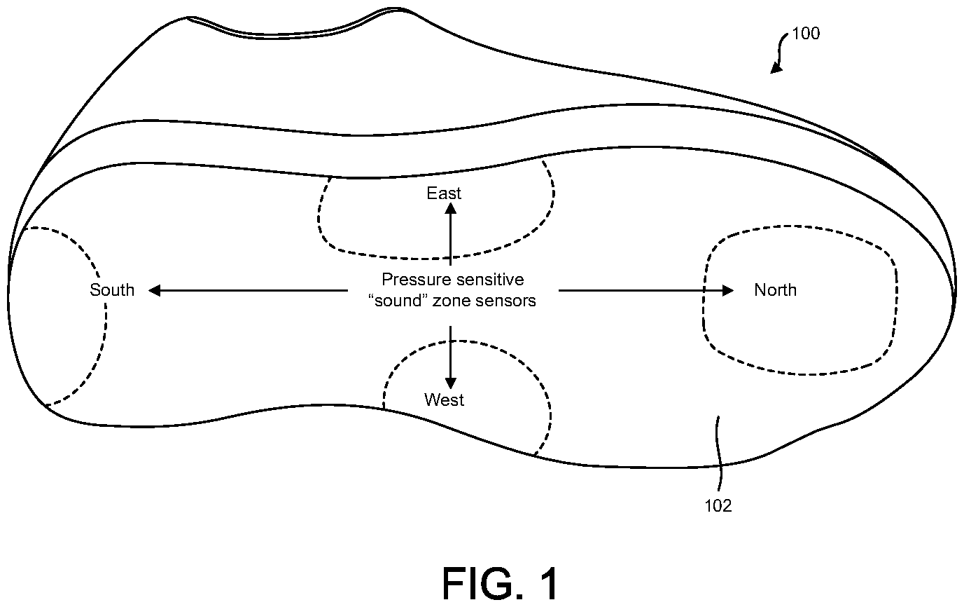

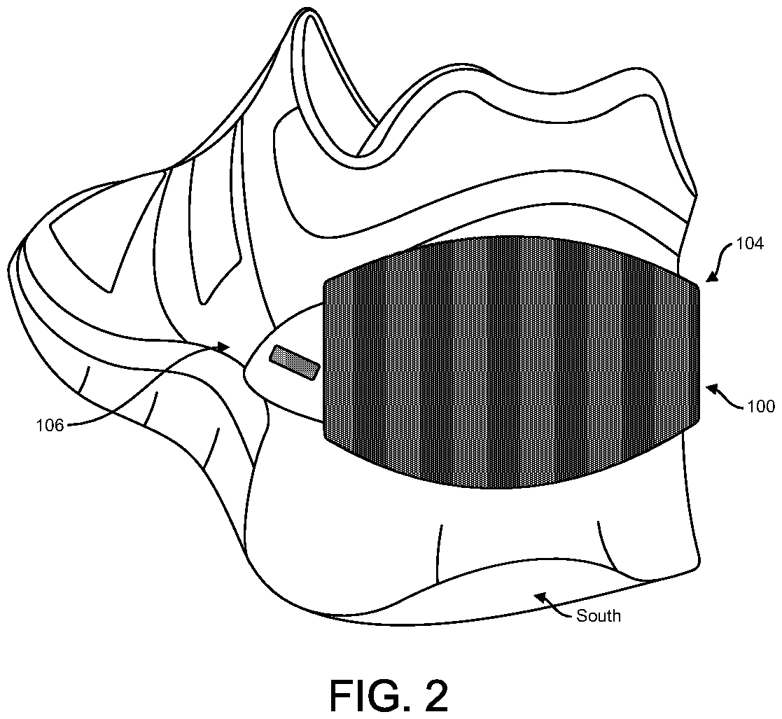

In some implementations, an analog version can include a limited number of pre-loaded sounds. Users can select which sounds they want to activate and which zone they want to assign to each sound by toggling through a small control panel built into the shoe. For example, and as illustrated in FIGS. 1 and 2, each footwear, in the form of a shoe 100, can have four zones—designated herein as North, South, East, and West. There can be more than four zones, as well as less than four zones. Each zone includes a sensor, such as a pressure sensor, that is embedded in or attached to the shoe proximate a zone. For instance, the sensors can be attached to the sole 102 of the shoe, or attached to an insole (not shown) of the shoe. Further, the sensors can be provided on the footbed of a shoe, or embedded within the material that makes up the sole 102, the insole, or the footbed, or anywhere therebetween.

The shoe can be associated with a memory having eight pre-loaded sounds, 1, 2, 3, 4, 5, 6, 7, and 8. There could be any number of sounds in the memory. The memory can be integrated with, or connected with, the shoe 100, or the memory can be remote, i.e. on a computing device such as a smartphone or the like. The user can assign, via a computer processor that receives user instructions and executes those instructions, each of the sounds to one or more of the zones. For example, a Sound 1 can be assigned to the North zone (next to the wearer's toes), a Sound 3 to the South zone (next to the wearer's heel), a Sound 5 to the East zone (the right side of each shoe), and a Sound 5 to the West zone (the left side of each shoe), and so on, or any combination above.

When the wearer applies pressure to any desired or particular zone, such as by pushing the shoe onto a surface with more pressure directed to the desired or particular zone, the desired sensor provided a feedback signal to the processor to generate the appropriate associated or designated sound, which can be played on a speaker connected with, or remote from, the shoe. The person can easily play songs or other sound patterns.

In some implementations, as shown in FIG. 2, the footwear, as depicted as shoe 100, can have a built-in or detachable speaker 104, to output sounds consistent with the associated or designated sound assigned to each sensor as activated. The shoe 100 and/or speaker 104 can further include a communication device 106, such as a Universal Serial Bus (USB) port, a Bluetooth transceiver, or a WiFi transceiver. The communication device 106 allows for communication with an external computing device for establishing settings like sensor sensitivity, updating software and/or firmware, or controlling the speaker 104.

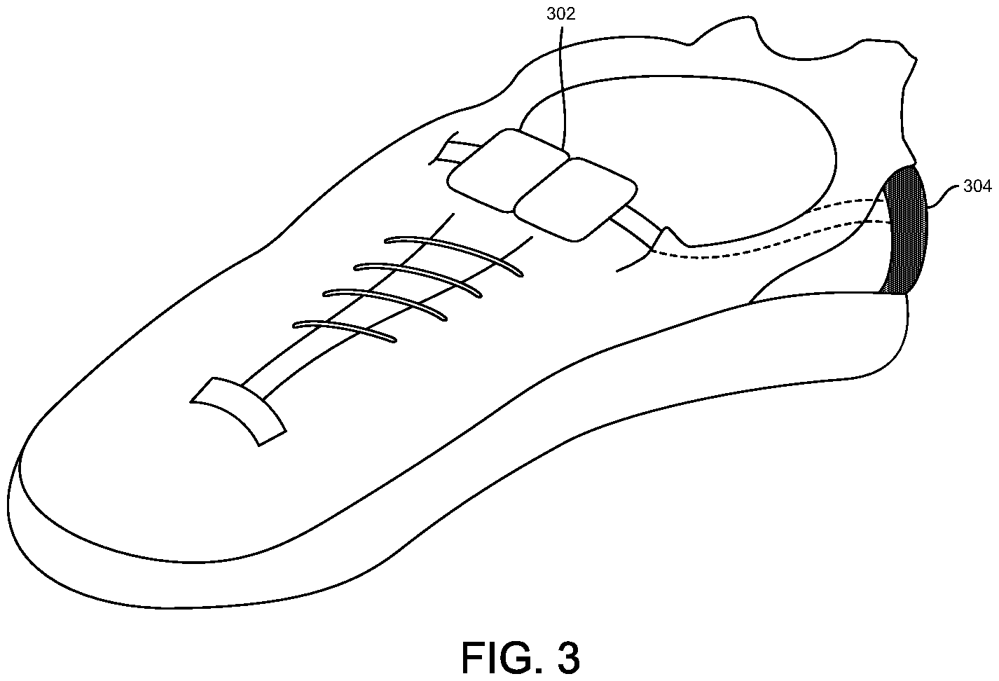

In some implementations, as shown in FIG. 3, a connector 302 such as a latch can be used when a shoe is worn by a user. By using the connector 302, the user can establish an electrical circuit for conducting electrical signals by which a speaker 304 can be powered to emit sound representing feedback from sensors of the footwear.

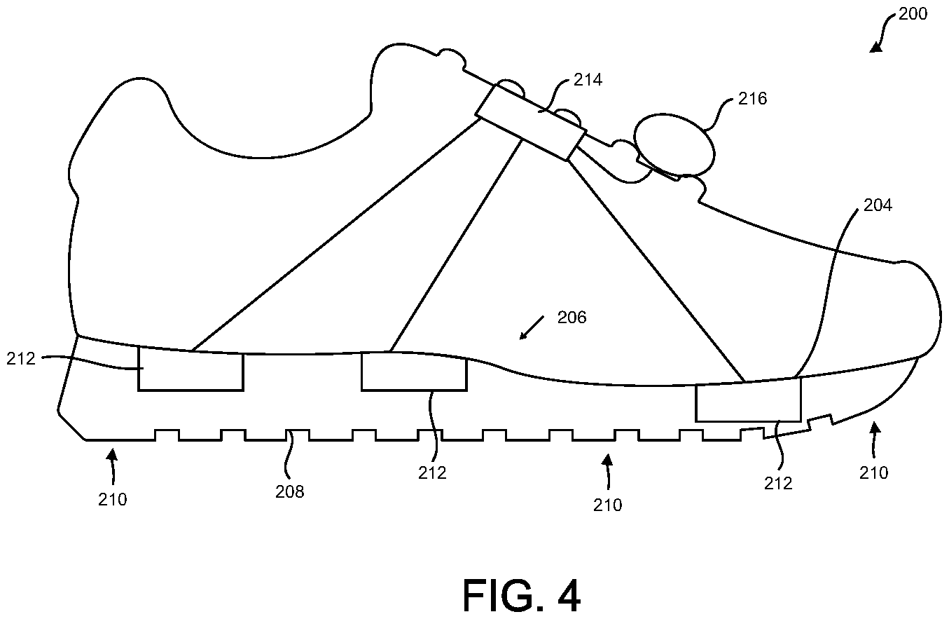

FIG. 4 shows a cross-section of feedback generating footwear 200. The footwear 200 can include a footbed 204 having a number of inner surface regions 206, and a sole 208 having a number of outer surface regions 210. The footwear 200 further includes one or more sensors 212. Each of the one or more sensors 212 can be positioned at a corresponding region of the plurality of inner and/or outer regions 206, 210 of the footwear. Each of the one or more sensors 212 has an assigned feedback that can be dynamically assigned by a remote computing device to each of the one or more sensors 212.

The assigned feedback can be generated upon activation of each of one of the one or more sensors 212 to generate the assigned feedback. Activation can include a threshold pressure applied on individual ones of the one or more sensors 212, or simply a touch of a sensor 212 to another surface. The threshold pressure can be dynamically adjusted, i.e. a sensitivity of each sensor 212 can be adjusted based on one of a number of settings.

The footwear 200 further includes a processor 214 coupled with the one or more sensors 212 to process the assigned feedback generated by each of the one or more sensors 212 to produce an electrical signal representing the assigned feedback generated by each of the one or more sensors 212. The footwear 200 can further include an output 216 coupled with the processor 214 to generate an audio or visual output signal of the electrical signal representing the assigned feedback. The output 216 can be an electrical communication port, such as a USB port or other communication port, or an output device, such as a speaker, headphone, video display or the other output device with which a user can receive an output.

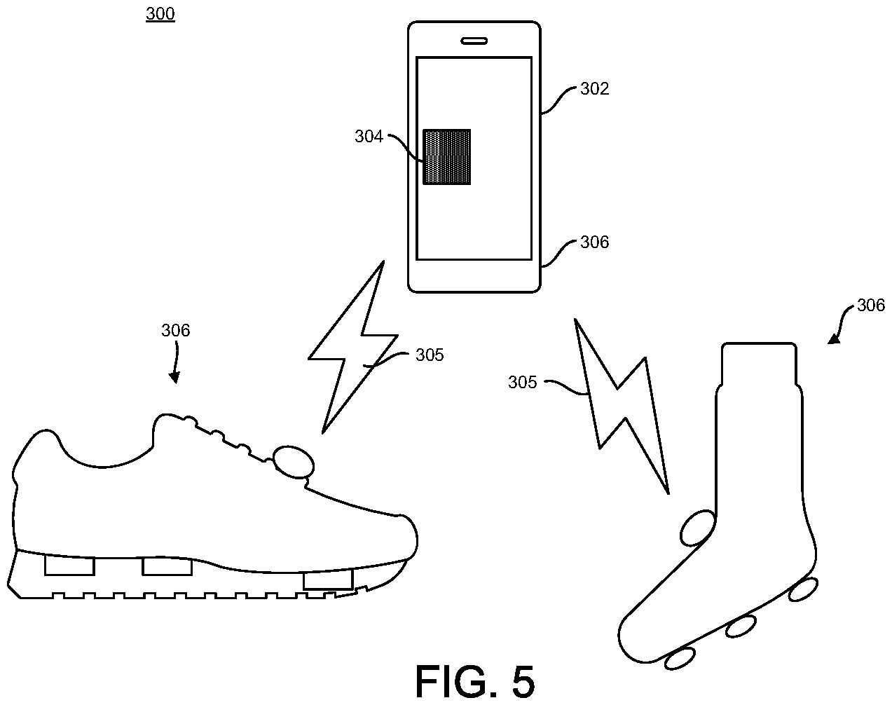

FIG. 5 illustrates a system 300 that includes a computing device 302 to execute one or more applications 304. The computing device 302 can be a mobile computing device, such as a smartphone or tablet computer, or other computing device. Each application 304 is configured to generate a display of feedback that selectable for assignment by a user. The feedback includes sounds such as musical notes, audio clips or files, and can also include signals to generate light or video.

The system 300 further includes feedback-generating footwear 306, as substantially described herein, that is in communication with the computing device. The footwear 306 can be a shoe or a sock, as shown, or can be other types of footwear, such as a sandal, a flip-flop, a boot, an insole, or even a foot wrap, such as might be made out of a stretchy material such as neoprene. The footwear 306 can be paired and connected with the computing device 302, through a pairing process via a communication link 305. The computing device 302 executes the application(s) 304 that receives feedback generated by the footwear. The application 304 can also be used to set-up and control the footwear, according to user preferences and settings. The system 300 further includes an output device 306 coupled with the processor to generate an audio or visual output of the electrical signal representing the assigned feedback. The output device 306 can be a speaker, a visual display, or a haptic device, or the like.

In some implementations, a wearer of the footwear, or a third party, can select the sounds they want from a library or palette of sounds, and then, via the app that is executable on the computing device, can assign each sound to a zone. The computing device can be a mobile computing device such as a mobile phone, a wearable computing device such as a smart watch, or can be a local processor that is embedded or otherwise associated with the shoe. The app can include a pre-installed or pre-configured library of sounds, but can also enable users to download other or additional sounds from the Internet or some other database, such as a cloud-based database or datastore. Further still, the app can be configured to enable the user to record their own sounds, using a microphone connected or associated with the computing device, or with the shoe. In accordance with these implementations, users can create more complicated songs by building individual tracks, to “record” songs onto the app, and to share those songs. Users can also play various games and challenge friends to play as well.

The app can include or provide further functions, such as storing pre-loaded sounds. In some implementations, through the app, the user can record their own sounds, or select sounds from a database or library. The app can enable a user to designate or “pair” particular sounds to certain sound-generating zones of the footwear, or pair each zone to a particular sound. The app can further allow updating of software and/or firmware that operates the footwear system, and can also be used to turn the sound-generating features ON or OFF.

In some implementations, a computing device can host and/or execute multiple apps for different uses and applications of the footwear and sensors as disclosed herein. Each app can have a control or graphical toggle to adjust a sensitivity and/or setting of each sensor individually, or of all the sensors collectively. The sensitivity and/or setting of each sensor can be pre-set based on the app, or user-controlled through the app. The sensitivity and/or setting can also be established based on an activity of the wearer of the footwear, such as whether the wearer is standing, sitting, running, etc., or based on what kind of footwear worn by the wearer.

Further, between apps, or even within one app, different modes can be provided, where the sensitivity and/or setting is customized for a particular use or application of the footwear, such as in the context of a video game that is at least partly controlled by the wearer's actions with the footwear. Further still, customized sensitivities and/or settings can be dynamically adjusted to optimize the use of the footwear. For instance, if a user of a computing device and/or wearer of the footwear switches among different apps, different settings and/or sensitivities can be applied to the sensors of the footwear, as well as a different assignment of a feedback from the activation of each sensor.

As described herein, footwear in accordance with implementations described herein can include one or more sensors that are configured to sense activity of the wearer, such as pressure on a particular zone or region of the footwear, movement of the footwear by the wearer, or position of the footwear as provided by the wearer. For instance, the one or more sensors associated with the footwear can include force-sensitive resistors, pressure sensors, and capacitive sensors. Other sensors that can be used include sensors for sensing movement and/or position of the footwear, such as a Global Positioning System (GPS) sensor, accelerometers, velocity sensors, or the like.

In some implementations, the footwear can include one or more biometric sensors to sense biometric activity of the wearer, such as a heartrate monitor, temperature sensor, blood pressure gauge, VO2 monitors, or other biometric sensors, such as electro-stimulation sensors to measure nerve activity.

In addition to playing sounds through built-in speakers, the app can be configured to allow a user to play sounds through remote speakers that receive the sound signals via wired or wireless connection. Examples of wireless-speakers include Bluetooth-enabled exterior speakers. The speakers can be loudspeakers, or headphones that are configured for being worn on or in a user's ears, such as earbuds. In some implementations, external speakers can be configured to be worn on a different part of the body of the user, such as a belt or on a shirt, or clipped to a pocket of an item of clothing such as a shirt or pants.

In some implementations, a music mode allows the speakers in the sneakers to play music from an associated music player, such as a mobile phone, tablet computer, laptop computer, or digital music player, via a Bluetooth connection, so that a user can listen and dance through their shoes, and/or add or layer a beat generated from their steps on top of music that is played.

The app can provide various uses for the footwear and the feedback. For instance, the app can be a game that challenges a wearer to generate specific sounds from contact of a specific region of the footwear with a surface. Alternatively, the gamification provided by the app can be useful in physical therapy, for example, to help coach a wearer into proper gait and foot movement. Further still, the system can be used in an augmented reality (AR), virtual reality (VR) and/or mobile gaming application.

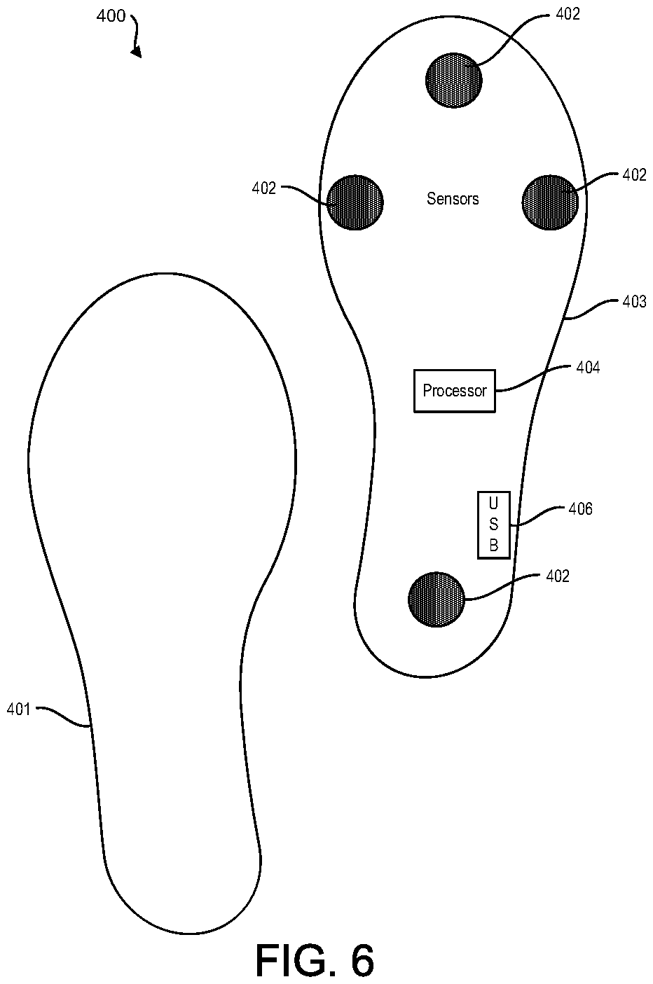

While the subject matter described herein relates to footwear, implementations of the current subject matter can include one or more components of footwear. FIG. 6 illustrates a top 401 and a bottom 403 of an insole 400, in accordance with implementations of the subject matter described herein. The insole 400 can be made of a pliable, flexible material such as a closed-cell or an open-celled foam, or a rubber or the like. The insole 400 can include a number of sensors 402 distributed about different regions, depicted in FIG. 6 as being distributed on the bottom 403 of the insole 400. While FIG. 6 also depicts the sensors 402 being distributed at a toe, a heel and at opposing sides of the bottom 403 of the insole 400, the distribution can include many more sensors 402 covering larger regions of the insole 400. Further, the sensors 402 can be embedded within the insole 400, between the top 401 and the bottom 403, or may be placed on the top 401 for direct communication with a wearer's foot and digits thereof.

The insole 400 can further include a processor 404 that is connected, or in communication, with each of the sensors 402. The processor 404 can be configured, on the fly or preconfigured, to receive a feedback that has been assigned to each of the sensors 402. For example, the sensor 402 at the toe can be activated by a wearer applying pressure to it more than other sensors 402, and the processor 404 will receive that relatively higher activation signal, which is then mapped to a particular feedback assigned to that sensor 402 at the toe. The processor 404 can in turn communicate that particular feedback to an output.

In some implementations, the output can include a communication port 406 connected with the processor 404. The communication port 406 can form the output to an output device, such as a speaker, a remote computing device, headphones, or the like. The communication port 406 can also function as a charge port, to charge the processor 404 and/or sensors 402. In some implementations, the communication port 406 can be a Universal Serial Bus (USB) connector, for transmitting both charge and data. Other types of interconnects can be used.

Although a few embodiments have been described in detail above, other modifications are possible. Other embodiments may be within the scope of the following claims.

1. Footwear comprising:
a footbed having a plurality of inner surface regions of the footwear;
a sole having a plurality of outer surface regions of the footwear;
one or more sensors, each of the one or more sensors being positioned at a corresponding region of the plurality of inner and/or outer regions of the footwear, each of the one or more sensors having an assigned feedback that is dynamically assigned by a remote computing device to each of the one or more sensors, the assigned feedback being generated upon activation of each of one of the one or more sensors to generate the assigned feedback;
a processor coupled with the one or more sensors to process the assigned feedback generated by each of the one or more sensors to produce an electrical signal representing the assigned feedback generated by each of the one or more sensors; and
an output coupled with the processor to generate an audio or visual output signal of the electrical signal representing the assigned feedback.

2. Footwear in accordance with claim 1, wherein the one or more sensors include at least one pressure sensor.

3. Footwear in accordance with claim 1, wherein the one or more sensors include at least one motion sensor.

4. Footwear in accordance with claim 1, wherein the output includes a communication port.

5. Footwear in accordance with claim 4, wherein the communication port includes a wireless transceiver.

6. Footwear in accordance with claim 1, further comprising an output device coupled with the output, and wherein the output device includes a speaker.

7. Footwear in accordance with claim 6, wherein the speaker is integrated with the remote computing device via a wireless link from the output of the footwear.

8. A system comprising:
a computing device to execute an application that generates a display of a plurality of feedback selectable for assignment by a user; and
footwear in communication with the computing device, the footwear comprising:
a footbed having a plurality of inner surface regions of the footwear;
a sole having a plurality of outer surface regions of the footwear;
one or more sensors, each of the one or more sensors being positioned at a corresponding region of the plurality of inner and/or outer regions of the footwear, each of the one or more sensors having an assigned feedback that is dynamically assigned by the computing device to each of the one or more sensors as selected by the user, the assigned feedback being generated upon activation of each of one of the one or more sensors to generate the assigned feedback; and
a processor coupled with the one or more sensors to process the assigned feedback generated by each of the one or more sensors to produce an electrical signal representing the assigned feedback generated by each of the one or more sensors; and
an output device coupled with the processor to generate an audio or visual output of the electrical signal representing the assigned feedback.

9. The system in accordance with claim 8, further comprising a wireless transceiver associated with the footwear to transmit the electrical signal wirelessly to the output.

10. The system in accordance with claim 8, wherein the output device includes a speaker, and the electrical signal is an audio signal configured for output from the speaker.

11. The system in accordance with claim 10, wherein the computing device includes the speaker.

12. The system in accordance with claim 10, wherein the one or more sensors include at least one pressure sensor.

13. Footwear in accordance with claim 10, wherein the one or more sensors include at least one motion sensor.

14. A system comprising:
a mobile computing device to execute an application that generates a display of a plurality of feedback that is selectable for assignment by a user; and
footwear having a footbed and a sole, the footwear further having a plurality of sensors on or between the footbed and the sole of the footwear, each of the plurality of sensors being positioned at a corresponding region of the footwear, each of the plurality of sensors having an assigned feedback from the selectable assignment by the mobile computing device, the assigned feedback being generated upon activation of each of one of the one or more sensors to generate the assigned feedback.

15. The system in accordance with claim 14, further comprising a processor coupled with the plurality of sensors to process the assigned feedback generated by each of the plurality sensors to produce an electrical signal representing the assigned feedback generated by each of the plurality of sensors.

16. The system in accordance with claim 15, further comprising an output device coupled with the processor to generate an audio or visual output of the electrical signal representing the assigned feedback.
